(19) United States
(12) Patent Application Publication
(10) Pub. No.: US 2014/0310209 A1
(43) Pub. Date: Oct. 16, 2014

(54) APPARATUS AND METHOD FOR SHARING TOPIC BETWEEN AUTONOMIC COMPUTING DEVICES

(71) Applicant: Electronics and Telecommunications Research Institute, Daejeon (KR)

(72) Inventors: Sung-Joo KANG, Seoul (KR); Yong-Yeon KIM, Daejeon (KR); In-Geol CHUN, Seoul (KR); Jeong-Min PARK, Daejeon (KR); Won-Tae KIM, Asan-si (KR)

(73) Assignee: Electronics and Telecommunications Research Institute, Daejeon (KR)

(21) Appl. No.: 14/206,408

(22) Filed: Mar. 12, 2014

(30) Foreign Application Priority Data
Apr. 11, 2013 (KR) 10-2013-0040085

(51) Int. Cl. G06N 99/00

(52) U.S. Cl. CPC G06N 99/005
USPC 706/12

(57) ABSTRACT

The present invention relates to an apparatus and method for sharing a topic between autonomic computing devices. The apparatus includes a knowledge base unit for storing information about abnormal states of an autonomic computing device. An autonomic computing management unit recognizes an abnormal state of the autonomic computing device based on the information about the abnormal states stored in the knowledge base unit, learns self-management for solving the abnormal state, and, when information about a new abnormal state is acquired during learning of self-management, generates a topic from the information about the new abnormal state. A topic transmission/reception unit transmits the topic generated by the autonomic computing management unit to a plurality of autonomic computing devices present in an identical domain or receives topics transmitted from the plurality of autonomic computing devices.

### CROSS REFERENCE TO RELATED APPLICATION

This application claims the benefit of Korean Patent Application No. 10-2013-0040085 filed on Apr. 11, 2013, which is hereby incorporated by reference in its entirety into this application.

### BACKGROUND OF THE INVENTION

1. Technical Field

The present invention relates generally to an apparatus and method for sharing a topic between autonomic computing devices and, more particularly, to an apparatus and method for sharing a topic between autonomic computing devices, which allow autonomic computing devices present in the same domain to mutually share a topic related to self-management learning therebetween.

2. Description of the Related Art

With the changing of the times, computing technology has moved into a new paradigm. With the explosive popularization of computing devices and various types of systems, software systems are configured to combine various types of system resources. In particular, in the fields of embedded systems, physical elements including large-scale sensors and actuators, and computing elements for controlling the physical elements are combined via communication middleware based on high-level reliability. Thus, embedded systems have evolved into the form of Cyber Physical Systems (CPS) that are systems for controlling and operating various convergence/hybrid systems surrounding human beings.

In this way, when a plurality of heterogeneous systems form a network and interact with a complicated physical environment bordered by each system, the complexity of system management occasionally exceeds the accommodation ability of human beings, and the surrounding physical environment of systems continuously changes. Accordingly, there is a problem in that various problematic situations the systems will encounter cannot be predicted in the stage of development. In order to cope with the complexity of system management and uncertainty of an operating environment, autonomic computing technology for developing, operating, and managing multiprocessor systems having self-management characteristics has been emphasized, as disclosed in Korean Patent Application Publication No. 10-2006-0063870. However, such autonomic computing technology recognizes abnormal states using only causes defined in a development stage and performs self-management based on solutions of the abnormal states, thus causing a problem in that reliability and stability are deteriorated for newly discovered abnormal states.

### SUMMARY OF THE INVENTION

Accordingly, the present invention has been made keeping in mind the above problems occurring in the prior art, and an object of the present invention is to provide an apparatus and method for sharing a topic between autonomic computing devices, which allow an autonomic computing device to share a topic, generated while recognizing abnormal states, analyzing the causes of abnormal states, establishing policies, and executing strategies for the policies, with other autonomic computing devices present in the same domain.

In accordance with an aspect of the present invention to accomplish the above object, there is provided an apparatus for sharing a topic between autonomic computing devices, including a knowledge base unit for storing information about abnormal states of an autonomic computing device; an autonomic computing management unit for recognizing an abnormal state of the autonomic computing device based on the information about the abnormal states stored in the knowledge base unit, learning self-management for solving the abnormal state, and, when information about a new abnormal state is acquired during learning of self-management, generating a topic from the information about the new abnormal state; and a topic transmission/reception unit for transmitting the topic generated by the autonomic computing management unit to a plurality of autonomic computing devices present in an identical domain or receiving topics transmitted from the plurality of autonomic computing devices.

Preferably, the topic may be a unit of information shared between the autonomic computing devices.

Preferably, the information about the abnormal states may include information about at least one of abnormal states, causes, policies, and strategies.

Preferably, the knowledge base unit may include a storage unit for storing the information about the abnormal states of the autonomic computing device; and an update unit for updating the information about the new abnormal state, provided by the autonomic computing management unit, in the storage unit.

Preferably, the storage unit may store unique Identification (ID), abnormal state ID, cause ID, policy ID, and strategy ID of the autonomic computing device, and satisfaction obtained when the corresponding abnormal state is solved, in a form of a mapping table.

Preferably, the autonomic computing management unit may include an abnormal state recognition unit configured to recognize an abnormal state based on state information of the autonomic computing device; a self-management learning unit configured to, when an abnormal state is recognized by the abnormal state recognition unit, learn self-management for analyzing a cause of the abnormal state based on the information about the abnormal states stored in the knowledge base unit, establishing a policy required to solve the abnormal state and executing a strategy, or learn self-management based on the topic transmitted from any one of the autonomic computing devices; a topic generation unit configured to, when information about a new abnormal state is acquired during learning of self-management by the self-management learning unit, generating the topic from the corresponding information; an information provision unit configured to provide the acquired information about the new abnormal state to the knowledge base unit; and a topic provision unit configured to provide the generated topic to the topic transmission/reception unit.

Preferably, a case where the self-management learning unit acquires the information about the new abnormal state may correspond to any one of a case where a new strategy having satisfaction higher than that of strategies previously stored in the knowledge base unit is learned, a case where it is learned that an abnormal state previously stored in the knowledge base unit is a symptom of a new cause, and a case where a new abnormal state is recognized and a procedure for solving the new abnormal state is learned.

Preferably, the topic generation unit may be configured to, when a new strategy is acquired, generate a structure-type topic from the strategy, when a new cause is acquired, generate a structure-type topic from the cause, and when a new abnormal state is recognized and a new procedure for solving the abnormal state is learned, generate structure-type topics from the new abnormal state, and a cause, a policy, and a strategy thereof, respectively.

Preferably, the topic transmission/reception unit may include a topic collection unit for collecting topics provided by the autonomic computing management unit; an address information unit for storing address information of the plurality of autonomic computing devices; a topic writing unit for notifying the plurality of autonomic computing devices of publication of the topics with reference to the stored address information, and if subscription responses are received from the autonomic computing devices, transmitting the topics to the autonomic computing devices; and a topic reading unit for receiving a topic transmitted from any one of the plurality of autonomic computing devices and providing the received topic to the autonomic computing management unit.

Preferably, the apparatus may further include an application program unit for providing state information of the autonomic computing device, and providing an interface for changing operation and setting of the autonomic computing device.

Preferably, the application program unit may include a sensor unit for acquiring the state information of the autonomic computing device; and an execution unit for executing start, termination, restart, and update of a processor of the autonomic computing device.

In accordance with another aspect of the present invention to accomplish the above object, there is provided a method for sharing a topic between autonomic computing devices, including storing, by a knowledge base unit, information about abnormal states of an autonomic computing device; recognizing, by an autonomic computing management unit, an abnormal state of the autonomic computing device based on the information about the abnormal states stored in the knowledge base unit, learning self-management for solving the abnormal state, and when information about a new abnormal state is acquired during learning of self-management, generating a topic from the information about the new abnormal state; and transmitting, by a topic transmission/reception unit, the topic generated by the autonomic computing management unit to a plurality of autonomic computing devices present in an identical domain in order to share the topic with the autonomic computing devices, or receiving topics from the plurality of autonomic computing devices.

Preferably, recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state may be configured to, if a new strategy having satisfaction higher than that of strategies previously stored in the knowledge base unit is learned, update a mapping table of the knowledge base unit based on information about the new strategy, and generate a structure-type topic from the new strategy.

Preferably, recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state may be configured to, if it is learned that an abnormal state stored in the knowledge base unit is a symptom of a new cause, update a mapping table of the knowledge base unit based on information about the new cause, and generate a structure-type topic from the new cause.

Preferably, recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state may be configured to, if a new abnormal state is recognized and a procedure for solving the abnormal state is learned, update a mapping table of the knowledge base unit based on information about learning of new self-management, and generate structure-type topics from the new abnormal state, and a cause, a policy, and a strategy thereof, respectively.

Preferably, transmitting the topic generated by the autonomic computing management unit to the plurality of autonomic computing devices present in the identical domain in order to share the topic or receiving the topics from the plurality of autonomic computing devices may be configured such that, when the autonomic computing device transmits the topic to the plurality of autonomic computing devices, the plurality of autonomic computing devices learn self-management based on the topic, and update their own knowledge base units belonging to the autonomic computing devices, respectively.

Preferably, transmitting the topic generated by the autonomic computing management unit to the plurality of autonomic computing devices present in the identical domain in order to share the topic or receiving the topics from the plurality of autonomic computing devices may be configured such that, when the autonomic computing device receives a topic transmitted from any one of the plurality of autonomic computing devices, the autonomic computing device learns self-management based on the received topic and updates the knowledge base unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a domain environment including an apparatus for sharing a topic between autonomic computing devices according to an embodiment of the present invention;

FIG. 2 is a diagram showing the schematic configuration of an apparatus for sharing a topic between autonomic computing devices according to an embodiment of the present invention;

FIG. 3 is a diagram showing the detailed configuration of a knowledge base unit employed in the apparatus for sharing a topic between autonomic computing devices according to an embodiment of the present invention;

FIG. 4 is a diagram showing the form of the mapping table of the knowledge base unit of FIG. 3;

FIG. 5 is a diagram showing the detailed configuration of an autonomic computing management unit employed in the apparatus for sharing a topic between autonomic computing devices according to an embodiment of the present invention;

FIG. 6 is a diagram showing structure-type topics according to an embodiment of the present invention;

FIG. 7 is a diagram showing the detailed configuration of a topic transmission/reception unit employed in the apparatus for sharing a topic between autonomic computing devices according to an embodiment of the present invention;

FIG. 8 is a diagram showing a topic publishing and subscription procedure performed by the topic transmission/reception unit of FIG. 7;

FIG. 9 is a diagram showing a topic transmission and reception procedure performed by the topic transmission/reception unit of FIG. 7;

FIG. 10 is a diagram showing the detailed configuration of an application program unit employed in the apparatus for sharing a topic between autonomic computing devices according to an embodiment of the present invention;

FIG. 11 is a flowchart showing the schematic sequence of a method for sharing a topic between autonomic computing devices according to an embodiment of the present invention;

FIG. 12 is a flowchart showing a procedure performed when a new strategy is learned in the method for sharing a topic between autonomic computing devices according to an embodiment of the present invention;

FIG. 13 is a flowchart showing a procedure performed when a new cause is learned in the method for sharing a topic between autonomic computing devices according to an embodiment of the present invention; and

FIG. 14 is a flowchart showing a procedure performed when a new self-management procedure is learned in the method for sharing a topic between autonomic computing devices according to an embodiment of the present invention.

### DESCRIPTION OF THE PREFERRED EMBODIMENTS

Hereinafter, preferred embodiments of the present invention will be described in detail with reference to the attached drawings so as to describe in detail the present invention to such an extent that those skilled in the art can easily implement the technical spirit of the present invention. Reference now should be made to the drawings, in which the same reference numerals are used throughout the different drawings to designate the same or similar components. In the following description, detailed descriptions of related known elements or functions that may unnecessarily make the gist of the present invention obscure will be omitted.

Below, an apparatus and method for sharing a topic between autonomic computing devices according to embodiments of the present invention will be described in detail with reference to the attached drawings.

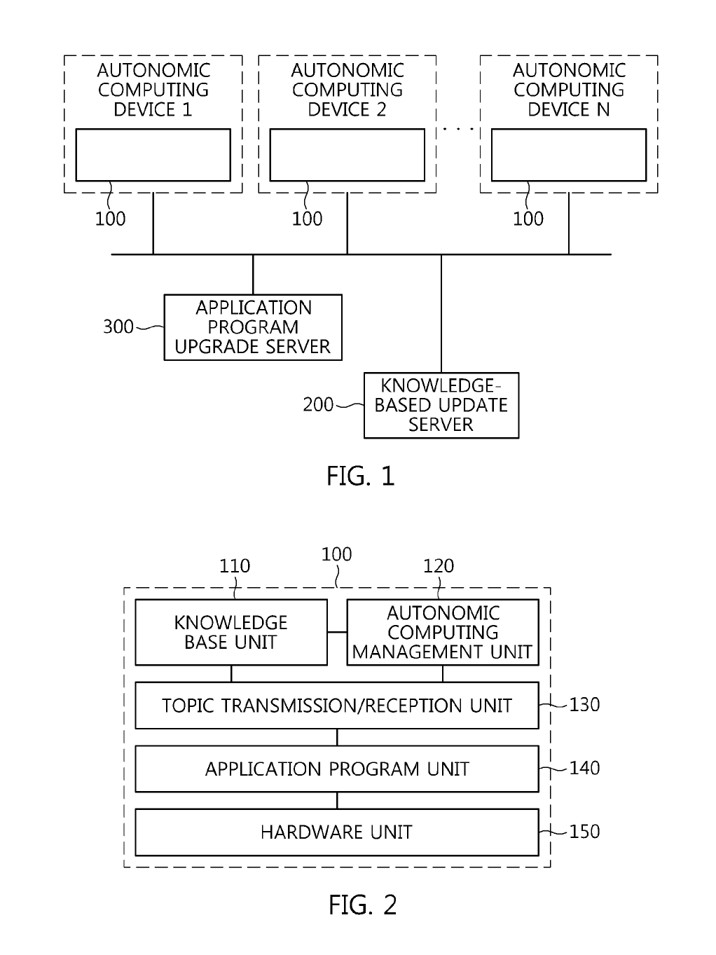

FIG. 1 is a diagram showing a domain environment including an apparatus for sharing a topic between autonomic computing devices according to an embodiment of the present invention.

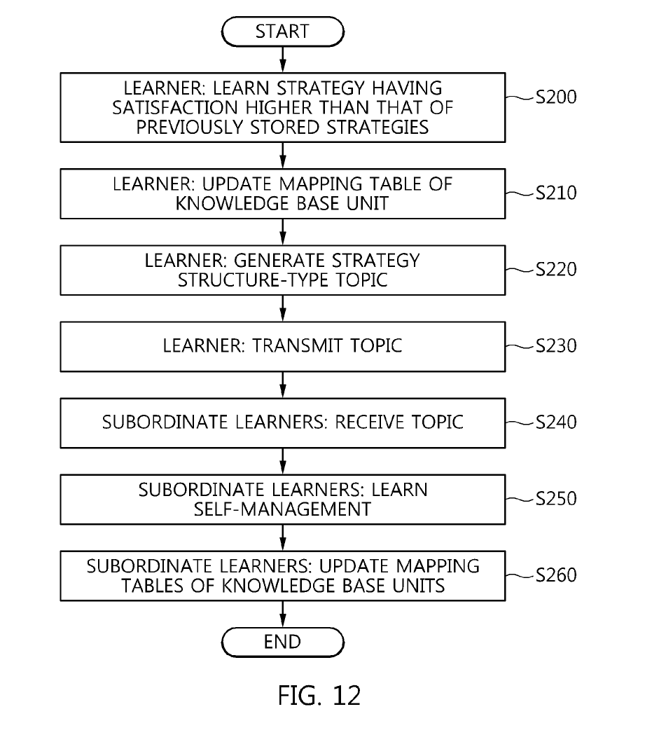

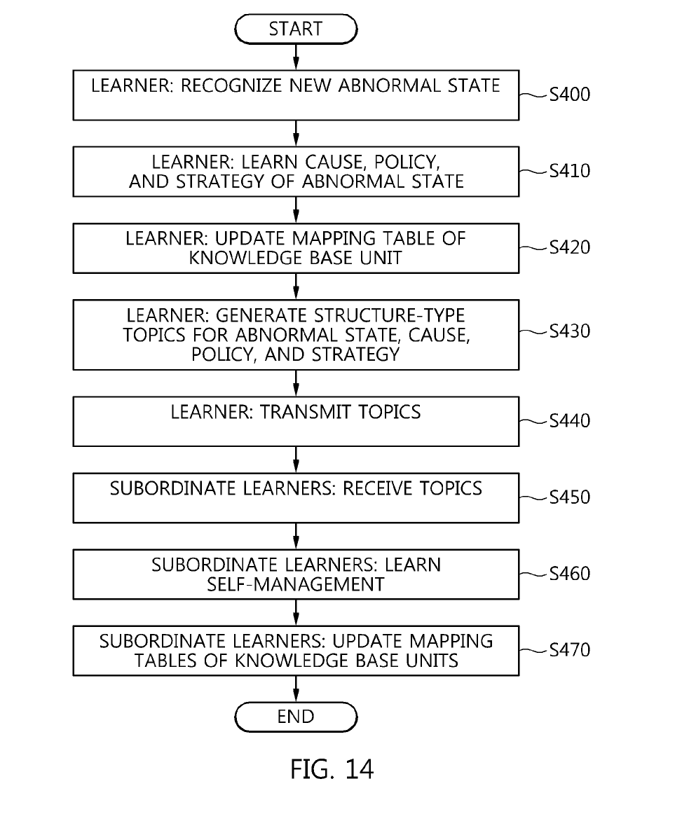

Referring to FIG. 1, the network environment according to the present invention is configured such that a plurality of autonomic computing devices 1 to N, each having an apparatus 100 for sharing a topic between autonomic computing devices, a knowledge-based update server 200, and an application program upgrade server 300 belong to a single domain. The plurality of autonomic computing devices 1 to N operate apparatuses for sharing topics using the same application program, and are configured such that, if a single autonomic computing device generates a topic for self-management learning, it may share the topic with other autonomic computing devices. In brief, when a scenario is initiated, one of the plurality of autonomic computing devices generates a topic. Thereafter, other autonomic computing devices 1 to N receive the corresponding topic. In this case, the autonomic computing devices 1 to N share the topic with each other via their own topic transmission/reception units 130 (see FIG. 2). Each of the autonomic computing devices 1 to N is configured to, when recognizing an abnormal state while performing its own operation, learn self-management for solving the abnormal state via an autonomic computing management unit 120 (see FIG. 2), and when acquiring information about a new abnormal state while learning self-management, generate a structure-type topic so that the acquired information may be shared with other autonomic computing devices. An embodiment based on this procedure will be described in detail later with reference to FIGS. 12 and 14.

The knowledge-based update server 200 is a developer-support tool and functions to, if new abnormal states, causes, policies, strategies, etc. related to systems which are previously distributed/operated are acquired, update the corresponding information about them in the knowledge base units 110 (see FIG. 2) of the respective autonomic computing devices. Further, similar to the knowledge-based update server, the application program upgrade server 300 is a developer-support tool, and functions to update the application program units 140 (see FIG. 2) of the respective autonomic computing devices.

FIG. 2 is a diagram showing the schematic configuration of an apparatus for sharing a topic between autonomic computing devices according to an embodiment of the present invention.

Referring to FIG. 2, an apparatus for sharing a topic between autonomic computing devices according to the present invention includes a knowledge base unit 110, an autonomic computing management unit 120, a topic transmission/reception unit 130, an application program unit 140, and a hardware unit 150. Here, an apparatus 100 for sharing a topic between autonomic computing devices is provided in each of a plurality of autonomic computing devices.

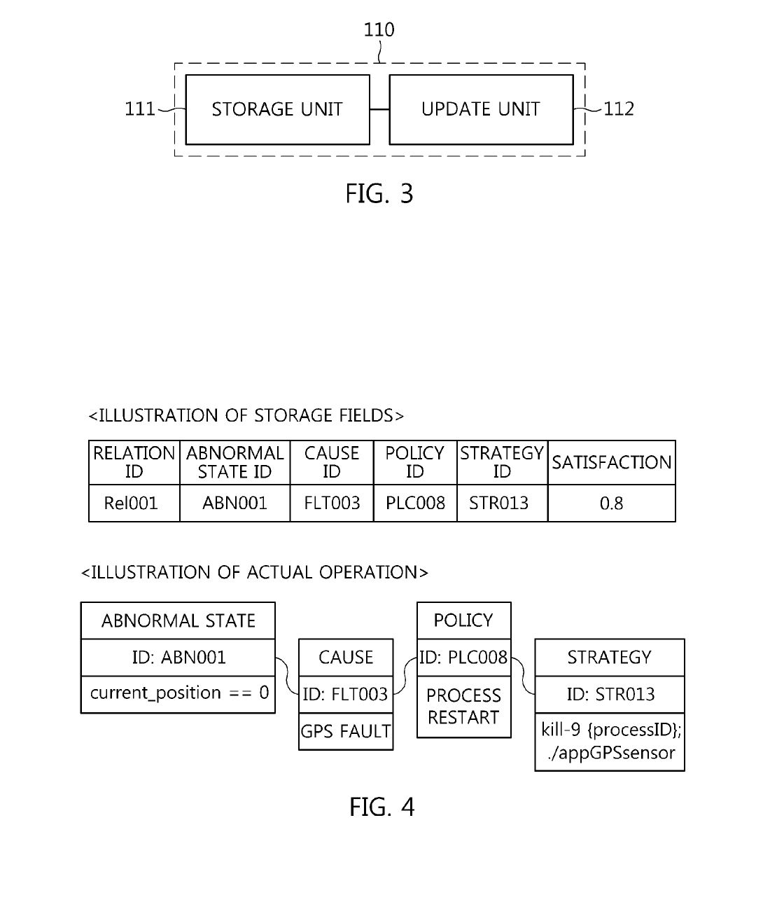

The knowledge base unit 110 stores information about the abnormal states of the corresponding autonomic computing device. The knowledge base unit 110 stores pieces of information about abnormal states, causes, policies, and strategies acquired in a development stage or during self-management learning, and satisfaction obtained when the abnormal states are solved, in the form of a mapping table. The detailed configuration of the knowledge base unit 110 and the form of the mapping table will be described in detail later with reference to FIGS. 3 and 4.

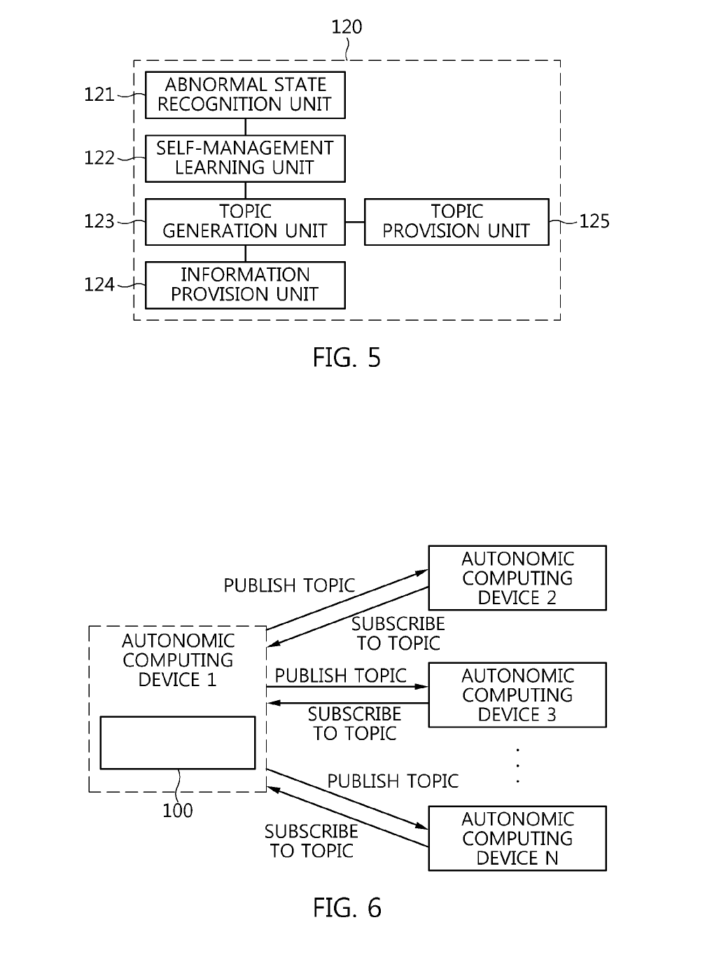

The autonomic computing management unit 120 recognizes the abnormal state of a corresponding one of autonomic computing devices 1 to N based on the information about abnormal states stored in the knowledge base unit 110, and learns self-management for solving the abnormal state. In this case, self-management learning denotes a series of procedures for, if the abnormal state of the corresponding one of autonomic computing devices 1 to N is recognized, analyzing the cause of the abnormal state based on the information about abnormal states stored in the knowledge base unit 110, establishing and selecting a policy for solving the abnormal state, and executing an optimal strategy for the selected policy. In detail, the autonomic computing management unit 120 denotes a computing system for diagnosing and managing its own abnormal state according to the management object assigned by a manager. That is, from the standpoint of server management, the operations of human beings are stored in a format recognizable by computing systems, and the autonomic computing management unit 120 is operated such that, if the computing system is abnormally operated, self-management is performed using the stored information. The detailed configuration of the autonomic computing management unit 120 will be described in detail later with reference to FIG. 5.

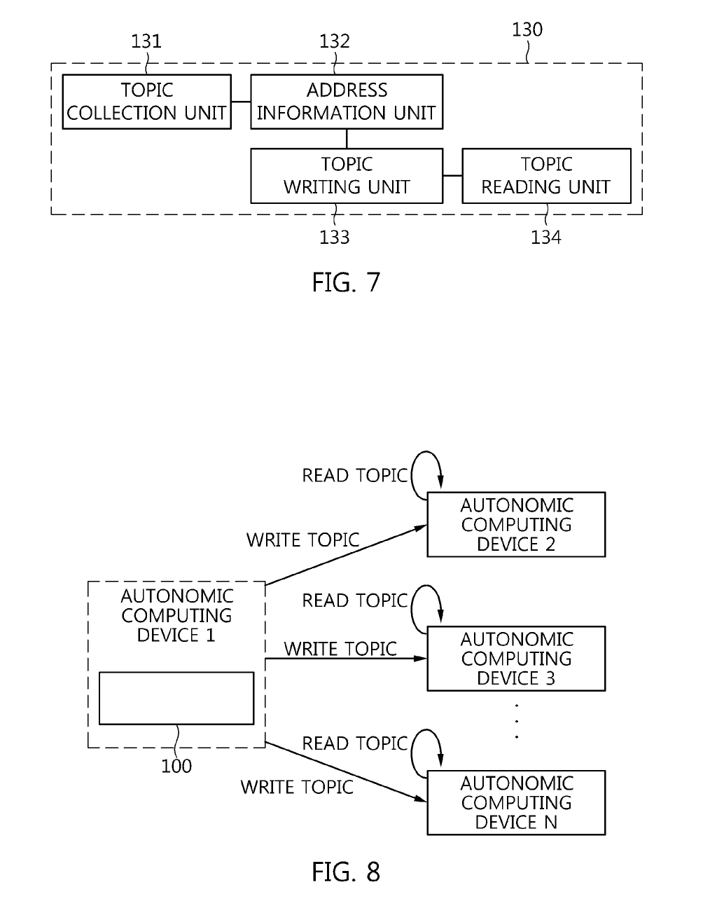

The topic transmission/reception unit 130 transmits a topic provided by the autonomic computing management unit 120 to the plurality of autonomic computing devices 1 to N present in the same domain, or receives topics transmitted from the plurality of autonomic computing devices 1 to N. The topic transmission/reception unit 130 is a data transmission/reception model differing from a client-server structure, and refers to networking middleware for simplifying complicated network programming A representative example thereof includes a Data Distribution Service (DDS) proposed by the Object Management Group (OMG) which is an international standardization group. Systems equipped with the topic transmission/reception unit 130 perform data transmission/reception on a topic basis. In this case, a topic is configured in a structure type, and the configuration of the topic will be described in detail later with reference to FIG. 6. Such a topic is set in a form in which one autonomic computing device publishes a topic and other autonomic computing devices 1 to N subscribe to the topic. That is, autonomic computing devices which share the topic in the same domain may transmit and receive the topic via write and read operations. An autonomic computing device desiring to transmit a topic performs a write operation on a specific topic, and notifies other autonomic computing devices that the topic has been published. Further, the other autonomic computing devices perform a read operation and then receive the topic if the topic corresponds to a topic for which they made subscription responses. In this case, the write operation is not necessarily performed only by the autonomic computing device which published the topic, and may be performed by other autonomic computing devices which subscribe to the topic. The detailed configuration of the topic transmission/reception unit will be described in detail with reference to FIG. 7.

The application program unit 140 provides the state information of the autonomic computing device, and provides an interface for changing the operation and setting of the autonomic computing device. The detailed configuration of the application program unit will be described in detail later with reference to FIG. 10.

The hardware unit 150 includes basic computing resources, such as the Central Processing Unit (CPU) and memory of the autonomic computing device, and sensors capable of acquiring the states of an external physical environment.

FIG. 3 is a diagram showing the detailed configuration of the knowledge base unit according to an embodiment of the present invention, and FIG. 4 is a diagram showing the form of the mapping table of the knowledge base unit of FIG. 3.

Referring to FIG. 3, the knowledge base unit 110 according to the present invention stores information about the abnormal states of the autonomic computing device. In this case, the abnormal state information includes information about at least one of abnormal states, causes, policies, and strategies.

The knowledge base unit 110 includes a storage unit 111 and an update unit 112.

The storage unit 111 stores information about the abnormal states of the autonomic computing device.

The update unit 112 updates information about a new abnormal state, provided by the autonomic computing management unit 120, in the storage unit.

Further, as shown in FIG. 4, the storage unit 111 stores the unique ID, abnormal state ID, cause ID, policy ID, and strategy ID of the autonomic computing device, and satisfaction, obtained when the abnormal state is solved, in the form of a mapping table.

In this case, ‘illustration of storage fields’ represents a mapping relation in the knowledge base unit 110, wherein fields of relation ID (Re1001), abnormal state ID (ABN001), cause ID (FLT003), policy ID (PLC008), strategy ID (STR013), and satisfaction (0.8) are indicated.

Meanwhile, ‘illustration of actual operation’ represents a relationship between pieces of actual information corresponding to respective IDs. For example, it is assumed that the application program of any ground moving object (any ground vehicle) receives a current position value from a Global Positioning System (GPS) and stores the value in variable current_position. The autonomic computing device monitors the variable using the sensor unit 141 of the application program unit 140, and recognizes that the autonomic computing device is not in a normal state if the value of the variable becomes ‘0’. Accordingly, the autonomic computing device knows that the cause of a state (ID:ABN001) in which the value in current_position is ‘0’ is a fault in the GPS (ID:FLT003) via the knowledge base unit 110, and sequentially executes ‘kill −9 {processID}’ and ‘./appGPSsendor’ instructions (ID:STR013) in compliance with process restart (ID:PLC008) which is a policy for the state.

FIG. 5 is a diagram showing the detailed configuration of the autonomic computing management unit according to an embodiment of the present invention, and FIG. 6 is a diagram showing structure-type topics according to an embodiment of the present invention.

Referring to FIG. 5, the autonomic computing management unit 120 according to the present invention recognizes the abnormal state of the autonomic computing device based on information about abnormal states stored in the knowledge base unit 110, learns self-management for solving the abnormal state, and generates a topic from information about a new abnormal state and provides the topic when the information about the new abnormal state is acquired during the learning of self-management.

The autonomic computing management unit 120 includes an abnormal state recognition unit 121, a self-management learning unit 122, a topic generation unit 123, an information provision unit 124, and a topic provision unit 125.

The abnormal state recognition unit 121 recognizes an abnormal state based on the state information of the autonomic computing device.

The self-management learning unit 122 is configured to, if the abnormal state is recognized by the abnormal state recognition unit 121, learn self-management for analyzing the cause of the abnormal state based on the information about abnormal states stored in the knowledge base unit 110, for establishing a policy required to solve the abnormal state, and for executing a strategy for the policy, or learn self-management based on the topic transmitted from one of the plurality of autonomic computing devices. A case where the self-management learning unit 122 acquires information about a new abnormal state may correspond to a case where a new strategy having satisfaction higher than that of strategies previously stored in the knowledge base unit 110 is learned, a case where it is learned that an abnormal state previously stored in the knowledge base unit 110 is the symptom of a new cause, and a case where a new abnormal state is recognized and a procedure for solving the abnormal state is learned.

The topic generation unit 123 is configured to, if information about a new abnormal state is acquired during the learning of self-management by the self-management learning unit 122, generate a topic from the corresponding information. Here, the term “topic” denotes the unit of information shared between the autonomic computing devices, and four topics related to an abnormal state, a cause, a policy, and a strategy are shared between autonomic computing devices 1 to N in the present invention.

As shown in FIG. 6, the topic generation unit 123 generates a topic in a structure type. That is, the topic generation unit 123 is configured to, when a new strategy is acquired, generate a structure-type topic from the corresponding strategy, when a new cause is acquired, generate a structure-type topic from the corresponding cause, and when a new abnormal state is recognized and a new procedure for solving the abnormal state is learned, generate structure-type topics from the corresponding abnormal state, and the cause, policy, and strategy thereof, respectively, and provide the structure-type topics.

The information provision unit 124 provides the acquired information about the new abnormal state to the knowledge base unit 110, and allows the storage unit of the knowledge base unit 110 to be updated.

The topic provision unit 125 provides the generated topics to the topic transmission/reception unit 130, and allows the topics to be transmitted to other autonomic computing devices.

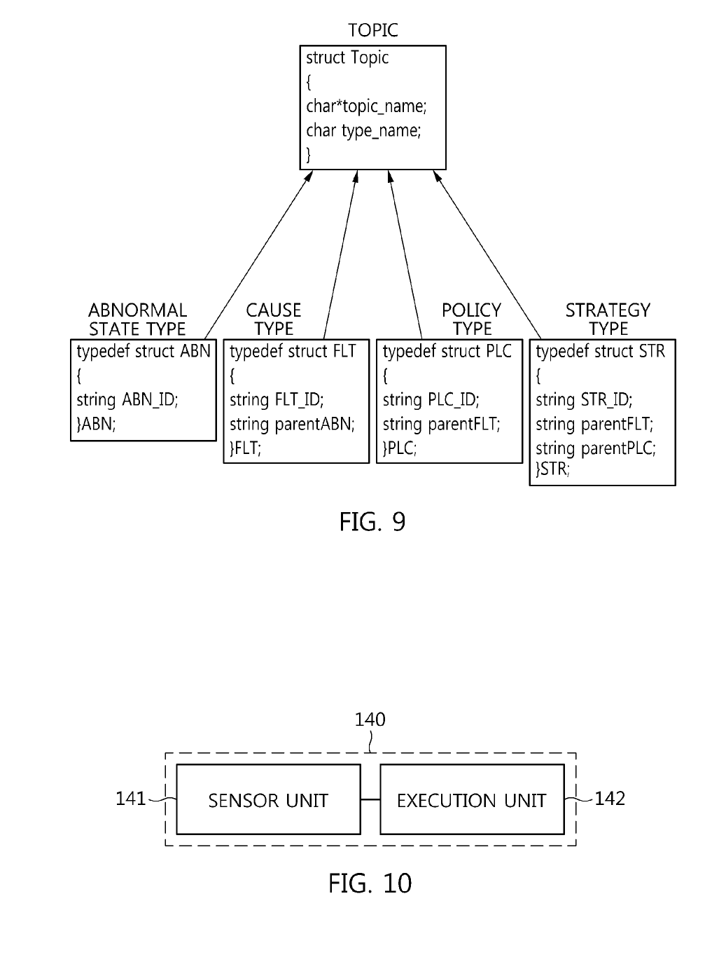

FIG. 7 is a diagram showing the detailed configuration of the topic transmission/reception unit according to an embodiment of the present invention, FIG. 8 is a diagram showing a topic publishing and subscription procedure performed by the topic transmission/reception unit of FIG. 7, and FIG. 9 is a diagram showing a topic transmission and reception procedure performed by the topic transmission/reception unit of FIG. 7.

Referring to FIG. 7, the topic transmission/reception unit 130 according to the present invention transmits each topic provided by the autonomic computing management unit 120 to a plurality of autonomic computing devices 1 to N present in the same domain, or receives topics transmitted from the plurality of autonomic computing devices 1 to N.

The topic transmission/reception unit 130 includes a topic collection unit 131, an address information unit 132, a topic writing unit 133, and a topic reading unit 134.

The topic collection unit 131 collects topics provided by the autonomic computing management unit 120.

The address information unit 132 stores the address information of the plurality of autonomic computing devices 1 to N.

The topic writing unit 133 notifies the plurality of autonomic computing devices of the publication of a topic with reference to the stored address information, as shown in FIG. 8, and transmits the topic, as shown in FIG. 9, if subscription responses have been received from the autonomic computing devices 1 to N.

The topic reading unit 134 receives a topic transmitted from any one of autonomic computing devices 1 to N and provides the topic to the autonomic computing management unit 120, as shown in FIG. 9.

FIG. 10 is a diagram showing the detailed configuration of the application program unit according to an embodiment of the present invention.

Referring to FIG. 10, the application program unit 140 according to the present invention provides the state information of the corresponding autonomic computing device and provides an interface for changing the operation and setting of the autonomic computing device.

The application program unit 140 includes a sensor unit 141 and an execution unit 142.

The sensor unit 141 acquires the state information of the autonomic computing device, and provides the state information to the abnormal state recognition unit 121 of the autonomic computing management unit 120.

The execution unit 142 performs the start, termination, restart, and update of the processor of the autonomic computing device.

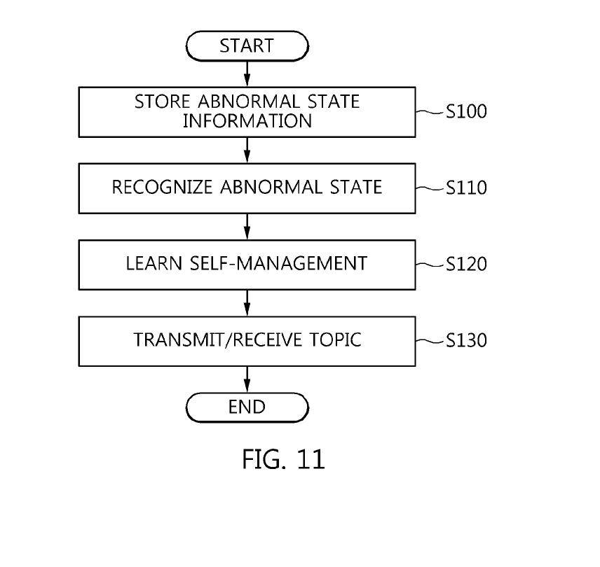

FIG. 11 is a flowchart showing the schematic flow of a method for sharing a topic between autonomic computing devices according to an embodiment of the present invention.

Referring to FIG. 11, by the knowledge base unit 110, information about the abnormal states of an autonomic computing device is stored at step S100.

Next, by the autonomic computing management unit 120, the abnormal state of a corresponding one of autonomic computing devices 1 to N is recognized based on the information about the abnormal states stored in the knowledge base unit 110 at step S110.

Then, by the autonomic computing management unit 120, self-management for solving the abnormal state is learned. When information about a new abnormal state is acquired during the learning of self-management, a topic is generated from information about the new abnormal state and is then provided at step S120. At step S120, a case where information about the new abnormal state is acquired may correspond to one of a case where a new strategy having satisfaction higher than that of strategies previously stored in the knowledge base unit 110 is learned, a case where it is learned that an abnormal state previously stored in the knowledge base unit 110 is the symptom of a new cause, and a case where a new abnormal state is recognized and a procedure for solving the abnormal state is learned. This will be described in detail later with reference to FIGS. 12 and 14.

Next, by the topic transmission/reception unit 130, the topic is transmitted to the plurality of autonomic computing devices 1 to N present in the same domain in order to share the topic provided by the autonomic computing management unit 120, or topics transmitted from the plurality of autonomic computing devices are received at step S130.

FIG. 12 is a flowchart showing a procedure performed when a new strategy is learned in the method for sharing a topic between autonomic computing devices according to an embodiment of the present invention.

Referring to FIG. 12, an autonomic computing device (hereinafter referred to as a ‘learner’) learns a new strategy having satisfaction higher than that of previously stored strategies at step S200.

Next, the learner updates the mapping table of the knowledge base unit 110 based on information about the new strategy at step S210. In this case, only the strategy information is updated without the abnormal state, cause, and policy information of the knowledge base unit 110 being changed.

Then, the learner generates a structure-type topic from the new strategy so as to share information about the new strategy with other autonomic computing devices (hereinafter referred to as ‘subordinate learners’) at step S220.

The learner transmits the topic to the subordinate learners through the topic transmission/reception unit 130 at step S230.

The subordinate learners receive the topic transmitted from the learner through their own topic transmission/reception units 130 at step S240.

The subordinate learners learn self-management based on the transmitted topic at step S250.

Finally, the subordinate learners update the mapping tables of their own knowledge base units 110 at step S260.

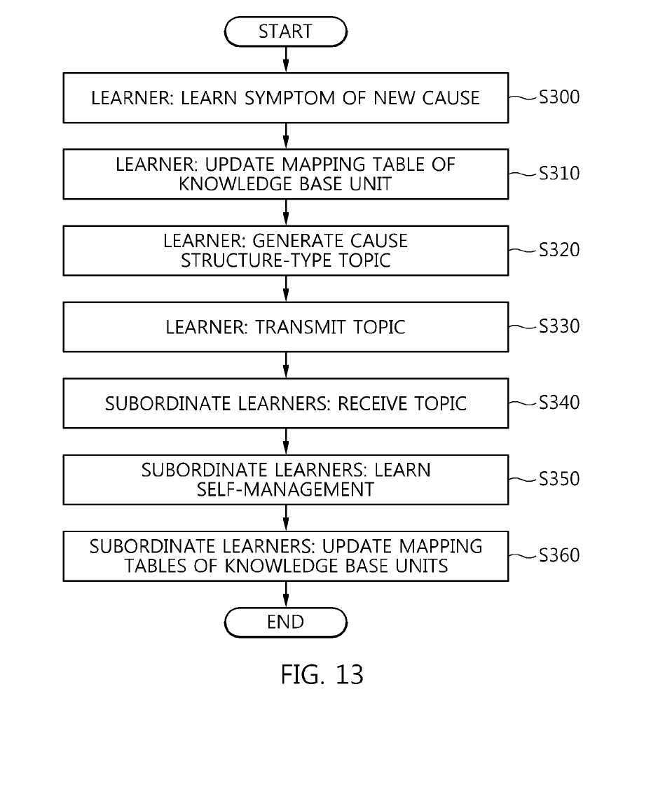

FIG. 13 is a flowchart showing a procedure performed when a new cause is learned in the method for sharing a topic between autonomic computing devices according to an embodiment of the present invention.

Referring to FIG. 13, a learner learns that a previously stored abnormal state is the symptom of a new cause at step S300.

Then, the learner updates the mapping table of the knowledge base unit 110 based on the information about the new cause at step S310. In this case, in the mapping table of the knowledge base unit 110, only cause information is updated.

Next, the learner generates a structure-type topic from the new cause so as to share information about the new cause with subordinate learners at step S320.

Then, the learner transmits the generated topic to the subordinate learners through the topic transmission/reception unit 130 at step S330.

The subordinate learners receive the topic transmitted from the learner through their own topic transmission/reception units 130 at step S340.

Then, the subordinate learners learn self-management based on the transmitted topic at step S350. That is, the subordinate learners analyze the received topic, determine that the topic is a structure-type topic for the cause, compare the topic with the information of the knowledge base unit 110, determine that information about the topic is new information, and learn self-management.

Finally, the subordinate learners update the mapping tables of their own knowledge base units 110 at step S360.

FIG. 14 is a flowchart showing a procedure performed when a new self-management procedure is learned in the method for sharing a topic between autonomic computing devices according to an embodiment of the present invention.

Referring to FIG. 14, a learner recognizes a new abnormal state at step S400, and learns a procedure for solving the abnormal state at step S410.

Then, the learner updates the mapping table of the knowledge base unit 110 based on information about a new self-management procedure at step S420. In this case, in the mapping table of the knowledge base unit 110, information about all of the abnormal state and the cause, policy, and strategy thereof is updated.

The learner generates structure-type topics from the new self-management procedure so as to share information about the new self-management procedure with subordinate learners at step S430.

Then, the learner transmits the generated topics to the subordinate learners through the topic transmission/reception unit 130 at step S440.

The subordinate learners receive the topics transmitted from the learner through their own topic transmission/reception units 130 at step S450.

The subordinate learners learn self-management based on the transmitted topics at step S460. That is, the subordinate learners analyze the received topics, determine that the topics are structure-type topics for the abnormal state, and the cause, policy, and strategy thereof, and learn self-management.

Finally, the subordinate learners update the mapping tables of their own knowledge base units 110 at step S470.

As described above, the apparatus and method for sharing a topic between autonomic computing devices according to the present invention allow the autonomic computing devices to share information about abnormal states acquired from a case where a new strategy having satisfaction higher than that of previously stored strategies is learned during self-management learning for abnormal states, a case where it is learned that a previously stored abnormal state is the symptom of a new cause, or a case where a new abnormal state is recognized, the abnormal state is analyzed, a policy is established, and a strategy is learned, thus improving the reliability and stability of autonomic computing.

In accordance with the apparatus and method for sharing a topic between autonomic computing devices according to the present invention, having the above configuration, there are advantages in that an autonomic computing device based on a network shares information about abnormal states, acquired from a case where a new strategy having satisfaction higher than that of previously stored strategies is learned during self-management learning, a case where it is learned that a previously stored abnormal state is the symptom of a new cause, or a case where a new abnormal state is recognized and a procedure for analyzing the abnormal state, establishing a policy, and executing a strategy is learned, with other autonomic computing devices, thus improving the reliability and stability of autonomic computing.

In this way, autonomic computing devices learn self-management for establishing optimal policies based on the occurrence of abnormal states and for executing strategies self-management in cooperation with each other, thus improving the overall performance and economic efficiency of autonomic computing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for sharing a topic between autonomic computing devices, comprising:
a knowledge base unit for storing information about abnormal states of an autonomic computing device;
an autonomic computing management unit for recognizing an abnormal state of the autonomic computing device based on the information about the abnormal states stored in the knowledge base unit, learning self-management for solving the abnormal state, and, when information about a new abnormal state is acquired during learning of self-management, generating a topic from the information about the new abnormal state; and
a topic transmission/reception unit for transmitting the topic generated by the autonomic computing management unit to a plurality of autonomic computing devices present in an identical domain or receiving topics transmitted from the plurality of autonomic computing devices.

2. The apparatus of claim 1, wherein the topic is a unit of information shared between the autonomic computing devices.

3. The apparatus of claim 1, wherein the information about the abnormal states includes information about at least one of abnormal states, causes, policies, and strategies.

4. The apparatus of claim 1, wherein the knowledge base unit comprises:
a storage unit for storing the information about the abnormal states of the autonomic computing device; and
an update unit for updating the information about the new abnormal state, provided by the autonomic computing management unit, in the storage unit.

5. The apparatus of claim 4, wherein the storage unit stores unique Identification (ID), abnormal state ID, cause ID, policy ID, and strategy ID of the autonomic computing device, and satisfaction obtained when the corresponding abnormal state is solved, in a form of a mapping table.

6. The apparatus of claim 1, wherein the autonomic computing management unit comprises:
an abnormal state recognition unit configured to recognize an abnormal state based on state information of the autonomic computing device;
a self-management learning unit configured to, when an abnormal state is recognized by the abnormal state recognition unit, learn self-management for analyzing a cause of the abnormal state based on the information about the abnormal states stored in the knowledge base unit, establishing a policy required to solve the abnormal state and executing a strategy, or learn self-management based on the topic transmitted from any one of the autonomic computing devices;
a topic generation unit configured to, when information about a new abnormal state is acquired during learning of self-management by the self-management learning unit, generating the topic from the corresponding information;
an information provision unit configured to provide the acquired information about the new abnormal state to the knowledge base unit; and
a topic provision unit configured to provide the generated topic to the topic transmission/reception unit.

7. The apparatus of claim 6, wherein a case where the self-management learning unit acquires the information about the new abnormal state corresponds to any one of a case where a new strategy having satisfaction higher than that of strategies previously stored in the knowledge base unit is learned, a case where it is learned that an abnormal state previously stored in the knowledge base unit is a symptom of a new cause, and a case where a new abnormal state is recognized and a procedure for solving the new abnormal state is learned.

8. The apparatus of claim 6, wherein the topic generation unit is configured to, when a new strategy is acquired, generate a structure-type topic from the strategy, when a new cause is acquired, generate a structure-type topic from the cause, and when a new abnormal state is recognized and a new procedure for solving the abnormal state is learned, generate structure-type topics from the new abnormal state, and a cause, a policy, and a strategy thereof, respectively.

9. The apparatus of claim 1, wherein the topic transmission/reception unit comprises:
a topic collection unit for collecting topics provided by the autonomic computing management unit;
an address information unit for storing address information of the plurality of autonomic computing devices;
a topic writing unit for notifying the plurality of autonomic computing devices of publication of the topics with reference to the stored address information, and if subscription responses are received from the autonomic computing devices, transmitting the topics to the autonomic computing devices; and
a topic reading unit for receiving a topic transmitted from any one of the plurality of autonomic computing devices and providing the received topic to the autonomic computing management unit.

10. The apparatus of claim 1, further comprising an application program unit for providing state information of the autonomic computing device, and providing an interface for changing operation and setting of the autonomic computing device.

11. The apparatus of claim 10, wherein the application program unit comprises:
a sensor unit for acquiring the state information of the autonomic computing device; and
an execution unit for executing start, termination, restart, and update of a processor of the autonomic computing device.

12. A method for sharing a topic between autonomic computing devices, comprising:
storing, by a knowledge base unit, information about abnormal states of an autonomic computing device;
recognizing, by an autonomic computing management unit, an abnormal state of the autonomic computing device based on the information about the abnormal states stored in the knowledge base unit, learning self-management for solving the abnormal state, and when information about a new abnormal state is acquired during learning of self-management, generating a topic from the information about the new abnormal state; and
transmitting, by a topic transmission/reception unit, the topic generated by the autonomic computing management unit to a plurality of autonomic computing devices present in an identical domain in order to share the topic with the autonomic computing devices, or receiving topics from the plurality of autonomic computing devices.

13. The method of claim 12, wherein recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state is configured to, if a new strategy having satisfaction higher than that of strategies previously stored in the knowledge base unit is learned, update a mapping table of the knowledge base unit based on information about the new strategy, and generate a structure-type topic from the new strategy.

14. The method of claim 12, wherein recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state is configured to, if it is learned that an abnormal state stored in the knowledge base unit is a symptom of a new cause, update a mapping table of the knowledge base unit based on information about the new cause, and generate a structure-type topic from the new cause.

15. The method of claim 12, wherein recognizing the abnormal state of the autonomic computing device based on the information about the abnormal states stored in the knowledge base unit, learning self-management for solving the abnormal state, and when information about the new abnormal state is acquired during learning of self-management, generating the topic from the information about the new abnormal state is configured to, if a new abnormal state is recognized and a procedure for solving the abnormal state is learned, update a mapping table of the knowledge base unit based on information about learning of new self-management, and generate structure-type topics from the new abnormal state, and a cause, a policy, and a strategy thereof, respectively.

16. The method of claim 12, wherein transmitting the topic generated by the autonomic computing management unit to the plurality of autonomic computing devices present in the identical domain in order to share the topic or receiving the topics from the plurality of autonomic computing devices is configured such that, when the autonomic computing device transmits the topic to the plurality of autonomic computing devices, the plurality of autonomic computing devices learn self-management based on the topic, and update their own knowledge base units belonging to the autonomic computing devices, respectively.

17. The method of claim 12, wherein transmitting the topic generated by the autonomic computing management unit to the plurality of autonomic computing devices present in the identical domain in order to share the topic or receiving the topics from the plurality of autonomic computing devices is configured such that, when the autonomic computing device receives a topic transmitted from any one of the plurality of autonomic computing devices, the autonomic computing device learns self-management based on the received topic and updates the knowledge base unit.
